(19) United States
(12) Patent Application Publication
(10) Pub. No.: US 2016/0092821 A1
(43) Pub. Date: Mar. 31, 2016

(54) NON-TRANSITORY COMPUTER READABLE MEDIUM STORING INFORMATION PRESENTING PROGRAM AND INFORMATION PROCESSING APPARATUS AND METHOD

(71) Applicant: FUJI XEROX CO., LTD., Tokyo (JP)

(72) Inventors: Ryota OZAKI, Kanagawa (JP); Daisuke IKEDA, Kanagawa (JP); Keiichi NEMOTO, Kanagawa (JP); Takeshi ONISHI, Kanagawa (JP); Noriji KATO, Kanagawa (JP)

(21) Appl. No.: 14/672,755

(22) Filed: Mar. 30, 2015

(30) Foreign Application Priority Data
Sep. 26, 2014 (JP) 2014-196778

(51) Int. Cl. G06Q 10/06; G06K 9/00

(52) U.S. Cl. CPC G06Q 10/06398; G06K 9/00335

(57) ABSTRACT

A non-transitory computer readable medium stores an information presenting program causing a computer to execute a process. The process includes: specifying a type of behavior of a working person within a structure; associating a customer within the structure with the working person; obtaining sales information concerning the customer; and registering the customer, the specified type of behavior of the working person, and the obtained sales information as information concerning the working person and presenting requested information from among the registered information.

### CROSS-REFERENCE TO RELATED APPLICATIONS

This application is based on and claims priority under 35 USC 119 from Japanese Patent Application No. 2014-196778 filed Sep. 26, 2014.

### BACKGROUND

### Technical Field

The present invention relates to a non-transitory computer readable medium storing an information presenting program and to an information processing apparatus and method.

### SUMMARY

According to an aspect of the invention, there is provided a non-transitory computer readable medium which stores an information presenting program causing a computer to execute a process. The process includes: specifying a type of behavior of a working person within a structure; associating a customer within the structure with the working person; obtaining sales information concerning the customer; and registering the customer, the specified type of behavior of the working person, and the obtained sales information as information concerning the working person and presenting requested information from among the registered information.

### BRIEF DESCRIPTION OF THE DRAWINGS

An exemplary embodiment of the present invention will be described in detail based on the following figures, wherein:

FIG. 1 is a schematic view illustrating an example of the configuration of a brick-and-mortar store;

FIG. 2 is a block diagram illustrating an example of the configuration of an information processing apparatus according to an exemplary embodiment;

FIG. 3 illustrates a screen for explaining an operation of a behavior-type specifying unit; and

FIG. 4 is a schematic diagram illustrating the configuration of customer serving information.

### DETAILED DESCRIPTION

### Exemplary Embodiment

### (Configuration of Brick-and-Mortar Store)

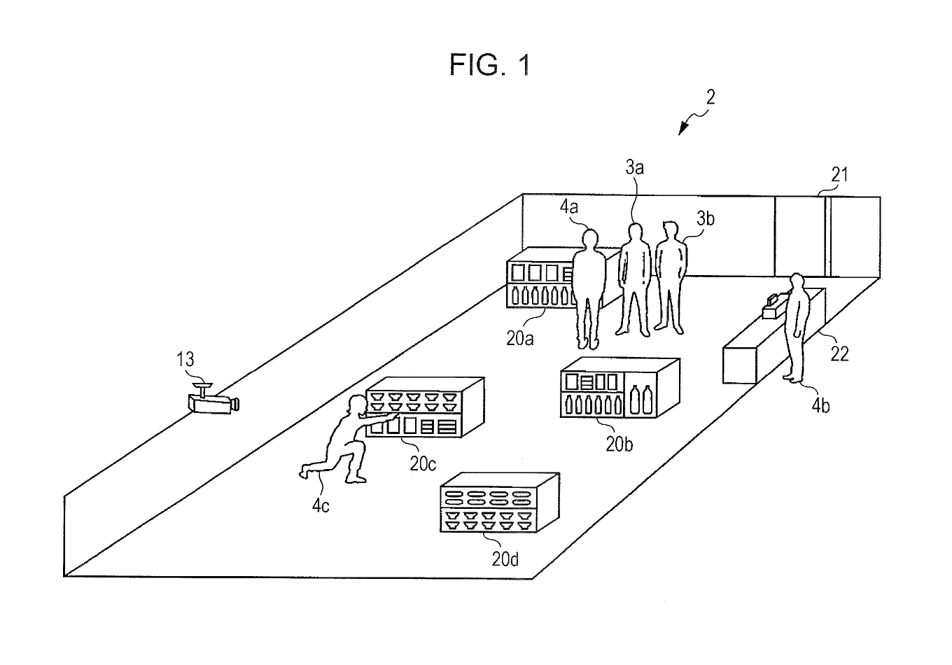

FIG. 1 is a schematic view illustrating an example of the configuration of a brick-and-mortar store 2.

The brick-and-mortar store 2 is a retail store, such as a corner store, and includes plural product items 20a through 20d displayed on shelves, and facilities installed in the brick-and-mortar store 2, such as an entrance 21 and a cash desk 22 (hereinafter such facilities will be referred to as “objects”). The product items 20a through 20d may be single product items, or may indicate product categories or product groups displayed on the shelves. Other examples of the objects are a bathroom, a copying machine, an automated teller machine, and a vending machine. The objects may be a fixed type or a movable type, which moves within the brick-and-mortar store 2.

In the brick-and-mortar store 2, customers 3a and 3b entered from the entrance 21 look around the brick-and-mortar store 2, and if they find a product item from among the product items 20a through 20d that they wish to purchase, they bring it to the cash desk 22 and settle the payment with a store clerk 4b. Every time the payment is settled at the cash desk 22, sales data is stored in a system, such as a point of sale (POS) system.

In the example shown in FIG. 1, a store clerk 4a is serving the customers 3a and 3b, while a store clerk 4b is sorting out the product items 20c. Examples of behavior types of the store clerks 4a through 4c are customer serving, sorting of product items, payment settlement, inspection, and customer attracting.

In the brick-and-mortar store 2, a camera 13 is installed. An information processing apparatus 1, which will be discussed later, identifies the positions of the store clerks 4a through 4c and customers 3a and 3b from video images captured by the camera 13 as the positions of persons. The positions of the store clerks 4a through 4c and customers 3a and 3b are also recorded in chronological order so as to recognize the behavior of the store clerks 4a through 4c and customers 3a and 3b. Video images captured by the camera 13 are subjected to image recognition processing, and the positions of the objects are recognized.

In the example shown in FIG. 1, the single camera 13 is shown. However, plural cameras 13 may be installed, and in addition to a normal camera, an omnidirectional camera may be used. The camera 13 may be a camera capturing video images or a camera capturing still images at predetermined intervals. The installation position of the camera 13 is registered in advance, and the coordinates of a video image captured by the camera 13 are associated with position coordinates within the brick-and-mortar store 2.

A “video image” is a set of plural frames (still images) captured in chronological order, and the plural frames are played back in chronological order.

### (Configuration of Information Processing Apparatus)

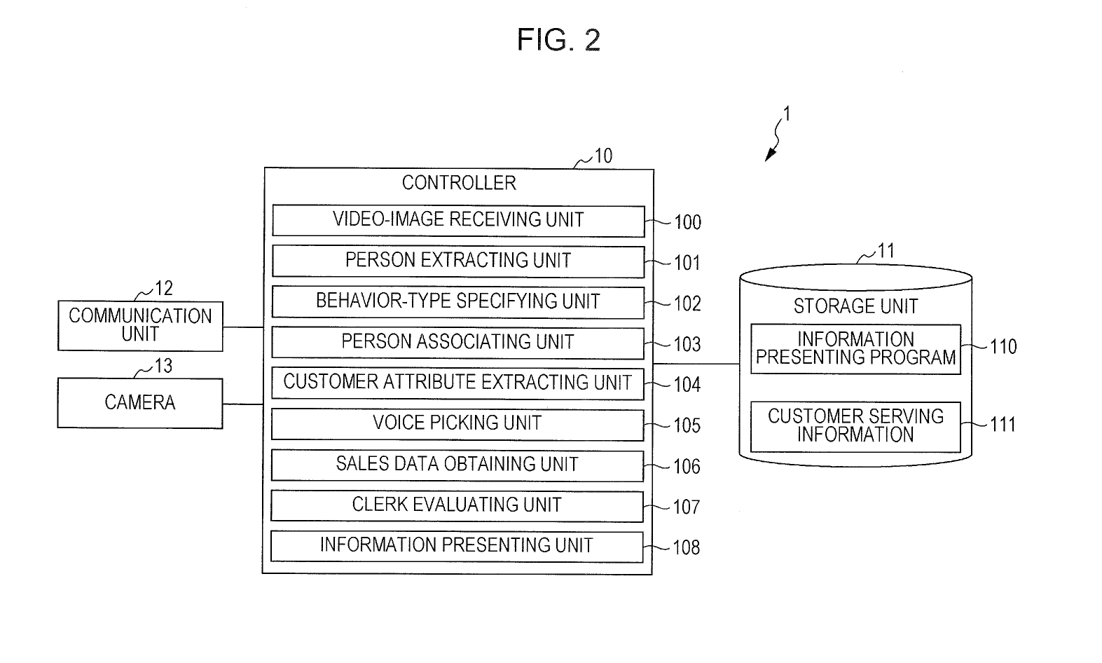

FIG. 2 is a block diagram illustrating an example of the configuration of the information processing apparatus 1 according to an exemplary embodiment.

The information processing apparatus 1 includes a controller 10, a storage unit 11, a communication unit 12, and the camera 13. The controller 10, which is constituted by, for example, a central processing unit (CPU), controls the individual elements of the information processing apparatus 1 and executes various programs. The storage unit 11 is constituted by a storage medium, such as a flash memory, and stores information therein. The communication unit 12 communicates with an external source via a network. The camera 13 captures video images or still images.

By executing an information presenting program 110, which will be discussed later, the controller 10 functions as a video-image receiving unit 100, a person extracting unit 101, a behavior-type specifying unit 102, a person associating unit 103, a customer attribute extracting unit 104, a voice picking unit 105, a sales data obtaining unit 106, a clerk evaluating unit 107, and an information presenting unit 108.

The video-image receiving unit 100 receives video image information generated by the camera 13 from captured video images.

The person extracting unit 101 extracts a person included in all or some of the frames of a video image indicated by the video image information received by the video-image receiving unit 100. If plural persons are included in the frames, the person extracting unit 101 identifies each of the persons. Concerning a registered person (such as a store clerk), the person extracting unit 101 may identify such a person on the basis of a registered image. A registered image may be converted into feature values in advance. Feature values are obtained by extracting feature points from an image by using Difference of Gaussians calculations and by extracting scale-invariant feature transform (SIFT) feature values from the feature points. Alternatively, fast invariant transform (FIT) feature values generated from gradient information indicating extracted feature points and their higher scale points may be used.

The behavior-type specifying unit 102 monitors each of the persons extracted by the person extracting unit 101 over time and specifies the type of behavior of each of the persons. For specifying the type of behavior of a person, a technique, such as optical flow estimation for performing matching between the behavior of this person and the registered behavior types, may be used. The behavior type is registered as one item of customer serving information 111.

If the type of behavior of a person specified by the behavior-type specifying unit 102 is related to another person, the person associating unit 103 associates these persons. Information concerning the association of persons is registered as one item of the customer serving information 111.

If a person extracted by the person extracting unit 101 is a customer, the customer attribute extracting unit 104 extracts the attributes of this customer from video image information. Examples of the attributes of a customer are the age, gender, the frequency of visiting the brick-and-mortar store 2, and the number of accompanying customers. If customer membership information is available and a customer can be specified from the membership information, the attributes of this customer may be extracted from the membership information.

The voice picking unit 105 picks the voice of customers and store clerks from the microphone equipped with the camera 13.

The sales data obtaining unit 106 obtains sales data from, for example, a POS system, when the payment is settled at the cash desk 22.

The clerk evaluating unit 107 calculates the evaluation values of the store clerks selling the product items, principally on the basis of the sales data obtained by the sales data obtaining unit 106 so as to evaluate the store clerks. The evaluation values are registered as one item of the customer serving information 111.

The information presenting unit 108 searches the content of the customer serving information 111, as information concerning the store clerks, on the basis of the conditions input from an external terminal connected to the information processing apparatus 1 via the communication unit 12, and presents the searched content of the customer serving information 111 on a display of the external terminal.

The storage unit 11 stores therein the information presenting program 110 and the customer serving information 111. The information presenting program 110 causes the controller 10 to operate as the video-image receiving unit 100, the person extracting unit 101, the behavior-type specifying unit 102, the person associating unit 103, the customer attribute extracting unit 104, the voice picking unit 105, the sales data obtaining unit 106, the clerk evaluating unit 107, and the information presenting unit 108.

### (Operation of Information Processing Apparatus)

The operation of this exemplary embodiment will be described below in terms of (1) an information generating operation and (2) information presenting operation.

### (1) Information Generating Operation

The camera 13 captures images of the customers 3a and 3b, the store clerks 4a through 4c, the product items 20a through 20c, the entrance 21, and the cash desk 22 within the brick-and-mortar store 2 and generates video image information.

The video-image receiving unit 100 of the information processing apparatus 1 receives the video image information generated by the camera 13.

The person extracting unit 101 extracts a person included in all or some of the frames of a video image indicated by the video image information received by the video-image receiving unit 100. If plural persons are included in the frames, the person extracting unit 101 identifies each of the persons. Concerning a registered person (such as a store clerk), the person extracting unit 101 identifies such a person on the basis of a registered image.

The behavior-type specifying unit 102 monitors each of the persons extracted by the person extracting unit 101 over time and specifies the type of behavior of each of the persons. The type of behavior of a person may be specified manually as follows.

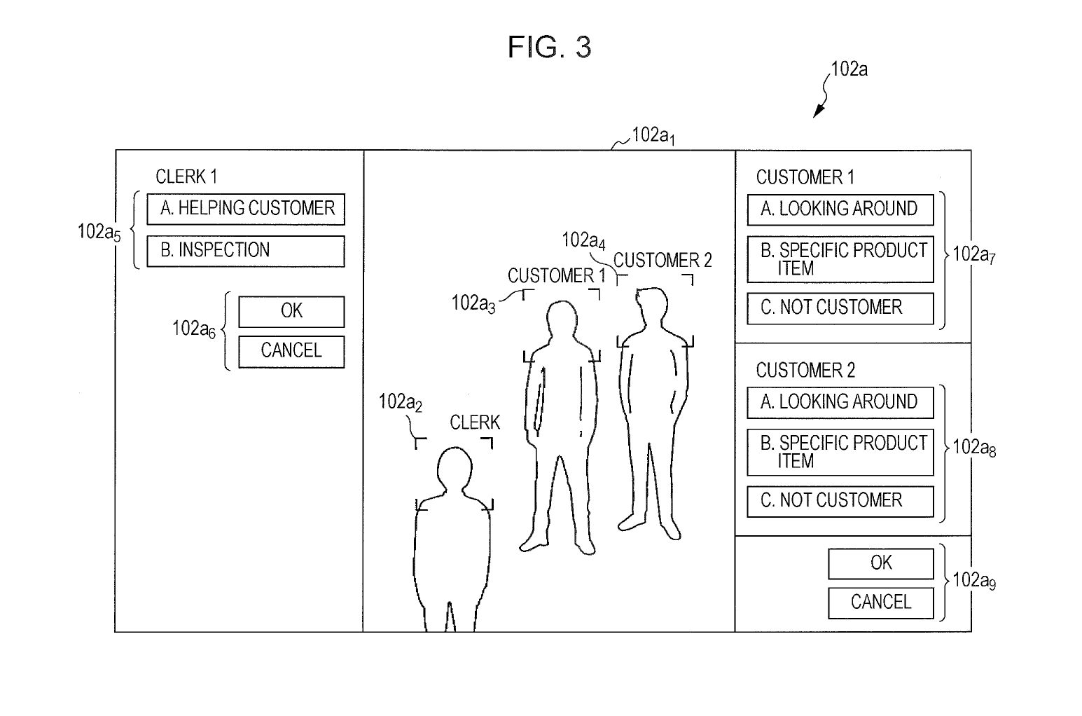

FIG. 3 illustrates a screen for explaining the operation of the behavior-type specifying unit 102.

A behavior-type specifying screen 102a is a screen displayed on a display (not shown) of the information processing apparatus 1 or a display of an external terminal connected to the information processing apparatus 1 via the communication unit 12. The behavior-type specifying unit 102 includes a video display area 102a₁ in which a video image captured by the camera 13 is displayed, windows 102a₂ through 102a₄ indicating persons extracted from the video display area 102a₁ by the person extracting unit 101, buttons 102a₅ for selecting the type of behavior of a “store clerk” indicated by the window 102a₂, buttons 102a₆ for setting or canceling the selected behavior type of this store clerk, buttons 102a₇ for selecting the type of behavior of a “customer 1” indicated by the window 102a₃, buttons 102a₈ for selecting the type of behavior of a “customer 2” indicated by the window 102a₄, and buttons 102a₉ for setting or canceling the selected behavior types of these customers.

The behavior-type specifying unit 102 presets candidates of behavior types of persons (store clerks and customers) and displays all the candidates on the behavior-type specifying screen 102a. However, if the behavior-type specifying unit 102 can assume some candidates of behavior types, such candidates may be displayed on the behavior-type specifying screen 102a. If the behavior-type specifying unit 102 assumes only one type of behavior of a person, it may not have to display it on the behavior-type specifying screen 102a.

For example, a manager checks the behavior-type specifying screen 102a and operates the buttons 102a₅ through 102a₉ so as to specify the types of behavior of “store clerk”, “customer 1”, and “customer 2”.

The behavior types are registered as one item of the customer serving information 111 in the following manner.

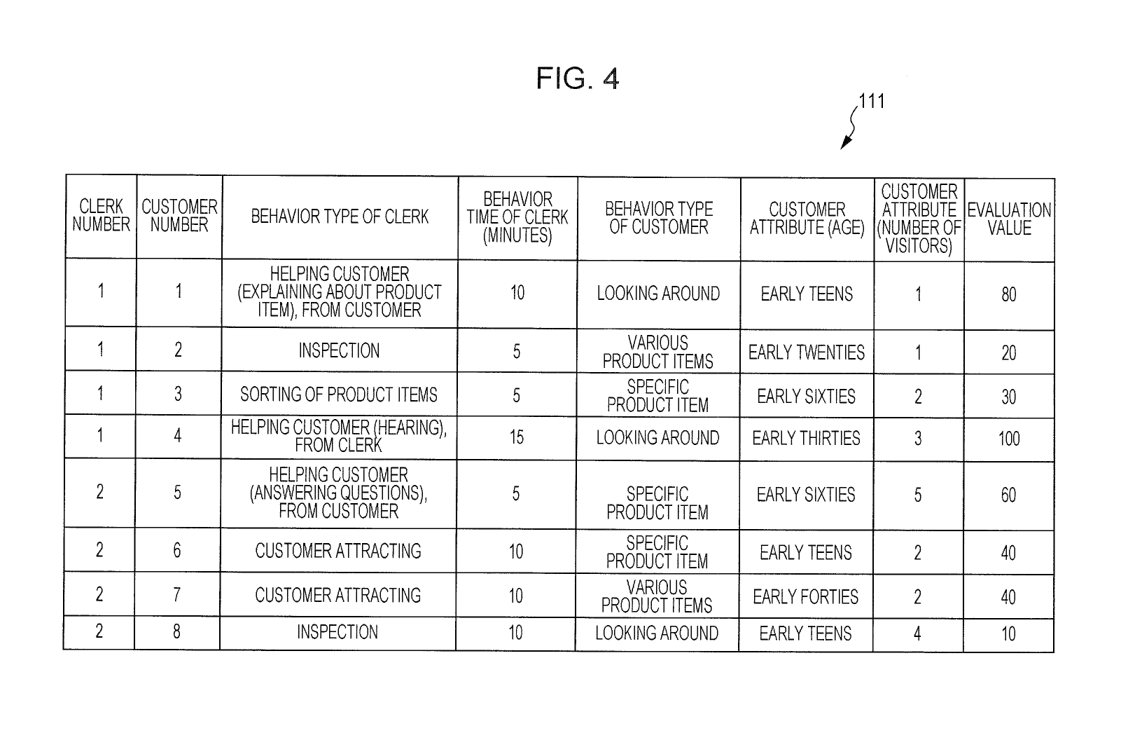

FIG. 4 is a schematic diagram illustrating the configuration of the customer serving information 111.

The customer serving information 111 indicates a clerk number for identifying a store clerk, a customer number for identifying a customer, the type of behavior of a store clerk specified by the behavior-type specifying unit 102, a time for which the specified type of behavior of a store clerk continues, the type of behavior of a customer specified by the behavior-type specifying unit 102, customer attributes extracted by the customer attribute extracting unit 104, such as the age and the number of accompanying customers (including this customer), and the evaluation value calculated by the clerk evaluating unit 107.

Then, if the type of behavior of a person specified by the behavior-type specifying unit 102 is related to another person, for example, if a store clerk is serving a customer, the person associating unit 103 associates this store clerk with this customer. Serving information concerning the association of persons is registered as one item of the customer serving information 111, as stated above. For example, as shown in FIG. 4, since the type of behavior of a store clerk of clerk number 1 is “helping” a customer of customer number 1 who is “looking around”, the store clerk of clerk number 1 is associated with the customer of customer number 1.

If a person extracted by the person extracting unit 101 is a customer, the customer attribute extracting unit 104 extracts the attributes of this customer from video image information. For example, as shown in FIG. 4, the customer attribute extracting unit 104 estimates the age of this customer and extracts the number of accompanying customers including this customer from the video image information and registers these attributes in the customer serving information 111.

Then, the voice picking unit 105 picks the voice of a customer and a store clerk from the microphone equipped with the camera 13. The picked voice is analyzed by a technology, such as natural language processing, and the talking persons and the type of talk (business talk, small talk, or talking to oneself) are specified.

Then, the sales data obtaining unit 106 obtains sales data from, for example, a POS system, when the payment is settled at the cash desk 22. The sales data obtaining unit 106 also determines which one of the persons extracted by the person extracting unit 101 is related to the obtained sales data.

The clerk evaluating unit 107 calculates the evaluation values of the store clerks selling product items, principally on the basis of the sales data obtained by the sales data obtaining unit 106 so as to evaluate the store clerks. The evaluation values are registered as one item of the customer serving information 111. The evaluation values are calculated from, for example, numeric values, such as the sales amount, the number of product items sold, and the time taken to sell a product item. The evaluation value may be calculated by the following equation: evaluation value=sales amount×α+the number of product items sold×β (α and β are weighting coefficients).

### (2) Information Presenting Operation

The information presenting unit 108 searches the content of the customer serving information 111 on the basis of the conditions input from an external terminal connected to the information processing apparatus 1 via the communication unit 12, and presents the searched content of the customer serving information 111 on a display of the external terminal.

The information presenting unit 108 presents information concerning store clerks. For example, if items of information concerning the evaluation value of 80 or higher are requested, the information presenting unit 108 presents an item of customer serving information concerning the clerk number 1 and the customer number 1 and an item of customer serving information concerning the clerk number 1 and the customer number 4. The information presenting unit 108 may filter items of customer serving information according to the customer attribute, such as the age or the number of customers visiting the brick-and-mortar store 2, or may calculate the average evaluation value of each clerk number. In this manner, the information presenting unit 108 may perform filtering processing or statistical processing concerning a desired item and output customer serving information. The information presenting unit 108 may present information according to the behavior type of store clerks or may extract a specific behavior type and present information concerning this behavior type.

### Other Exemplary Embodiments

The present invention is not restricted to the above-described exemplary embodiment, and may be modified in various manners within the spirit of the invention.

In the above-described exemplary embodiment, behavior types of store clerks in the brick-and-mortar store 2 are specified. However, the location in which behavior types are specified is not restricted to the brick-and-mortar store 2. The above-described exemplary embodiment may be applied to structures within which types of behavior of working persons are specified. Examples of the structures are eating places (restaurants), shopping malls, buildings, airports, stations, hospitals, schools, and leisure facilities. The structures may be moving objects, such as airplanes and ships. In the case of restaurants, behavior types of servers, such as customer attracting, inspection, and customer helping (helping customers with menus and answering questions from customers). In this case, examples of sales information concerning customers are menu items ordered by customers and the amount paid by the customers. In the case of a building or an airport, behavior types of clerks and servers working in a building or an airport are specified.

In the above-described exemplary embodiment, the functions of the video-image receiving unit 100, the person extracting unit 101, the behavior-type specifying unit 102, a person associating unit 103, the customer attribute extracting unit 104, the voice picking unit 105, the sales data obtaining unit 106, the clerk evaluating unit 107, and the information presenting unit 108 are implemented by the program. However, all or some of these functions may be implemented by hardware, such as an application-specific integrated circuit (ASIC). Alternatively, the program used in the above-described exemplary embodiment may be stored in a recording medium, such as a compact disc-read only memory (CD-ROM) and provided. Concerning the operations discussed in the above-described exemplary embodiment, such as the operations of the individual elements of the information processing apparatus 1, the order of such operations may be changed, and the operations may be deleted and another operation may be added.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing an information presenting program causing a computer to execute a process, the process comprising:
specifying a type of behavior of a working person within a structure;
associating a customer within the structure with the working person;
obtaining sales information concerning the customer; and
registering the customer, the specified type of behavior of the working person, and the obtained sales information as information concerning the working person and presenting requested information from among the registered information.

2. The non-transitory computer readable medium according to claim 1, wherein:
the process further comprises extracting the customer and the working person from an image captured by a camera; and
a type of behavior of the working person or a type of behavior of the working person in relation to the customer is specified from an image captured by the camera.

3. The non-transitory computer readable medium according to claim 1, wherein:
the process further comprises calculating an evaluation value for evaluating the working person on the basis of the sales information; and
the evaluation value is presented as the information concerning the working person.

4. The non-transitory computer readable medium according to claim 2, wherein:
the process further comprises calculating an evaluation value for evaluating the working person on the basis of the sales information; and
the evaluation value is presented as the information concerning the working person.

5. An information processing apparatus comprising:
a specifying unit that specifies a type of behavior of a working person within a structure;
an associating unit that associates a customer within the structure with the working person;
an obtaining unit that obtains sales information concerning the customer; and
a presenting unit that registers the customer, the specified type of behavior of the working person, and the obtained sales information as information concerning the working person and that presents requested information from among the registered information.

6. An information processing method comprising:
specifying a type of behavior of a working person within a structure;
associating a customer within the structure with the working person;
obtaining sales information concerning the customer; and
registering the customer, the specified type of behavior of the working person, and the obtained sales information as information concerning the working person and presenting requested information from among the registered information.
